(19) United States
(12) Patent Application Publication
(10) Pub. No.: US 2017/0090583 A1
(43) Pub. Date: Mar. 30, 2017

(54) ACTIVITY DETECTION FOR GESTURE RECOGNITION

(71) Applicant: Intel Corporation, Santa Clara, CA (US)

(72) Inventors: Julio Cesar Zamora Esquivel, Zapopan (MX); Jose Rodrigo CAMACHO PEREZ, Guadalajara Jalisco (MX)

(21) Appl. No.: 14/865,541

(22) Filed: Sep. 25, 2015

(51) Int. Cl. G06F 3/01

(52) U.S. Cl. CPC G06F 3/017

(57) ABSTRACT

An electronic apparatus may be provided that includes a sensor to detect movement of the apparatus, and to provide a plurality of signals based on the detected movement. A gesture activity detector may receive the signals from the sensor, and may determine occurrence of a valid gesture pattern based on the received signals. A gesture classifier may identify a gesture based on signals from the sensor, wherein operation of the gesture classifier is based on the determination of the gesture activity detector.

### BACKGROUND

1. Field

Embodiments may relate to controlling power of a gesture classifier.

2. Background

Modern clothing and other wearable accessories may incorporate computing or other advanced electronic technologies. Such computing and/or advanced electronic technologies may be incorporated for various functional reasons or may be incorporated for purely aesthetic reasons. Such clothing and other wearable accessories may be referred to as wearable technology or wearable devices. Wearable devices may interpret gestures of a user. A gesture may be any type of movement of part of the body (e.g., a hand, head, facial expression, etc.) to express an idea or meaning. However, gestures may need to be determined, identified or classified by a gesture classifier.

### BRIEF DESCRIPTION OF THE DRAWINGS

Arrangements and embodiments may be described in detail with reference to the following drawings in which like reference numerals refer to like elements and wherein:

FIG. 1 is a schematic illustration of wrist-based wearable device that may be adapted to work with electronic devices in accordance with some examples;

FIG. 2 is a schematic illustration of an architecture for a wrist-based wearable device that may be adapted to work with electronic devices in accordance with some examples;

FIG. 3 is a schematic illustration of components of an electronic device that may be adapted to work with a wrist-based wearable device in accordance with some examples;

FIGS. 4A-4C are schematic illustrations of gestures that may be used with a wrist-based wearable device in accordance with some examples;

FIG. 5 shows an electronic system according to an example embodiment;

FIG. 6 is a flowchart showing operations within a gesture activity detector according to an example embodiment;

FIG. 7 is a graph showing samples and amplitude for a snap gesture; and

FIG. 8 is a close up view of the gesture signal from FIG. 7.

### DETAILED DESCRIPTION

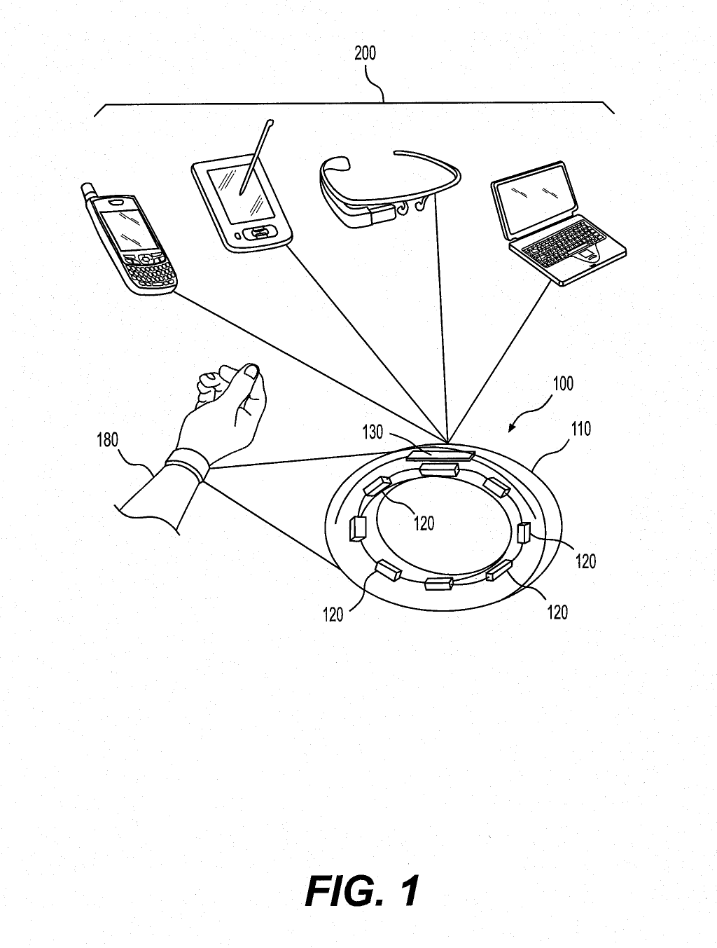

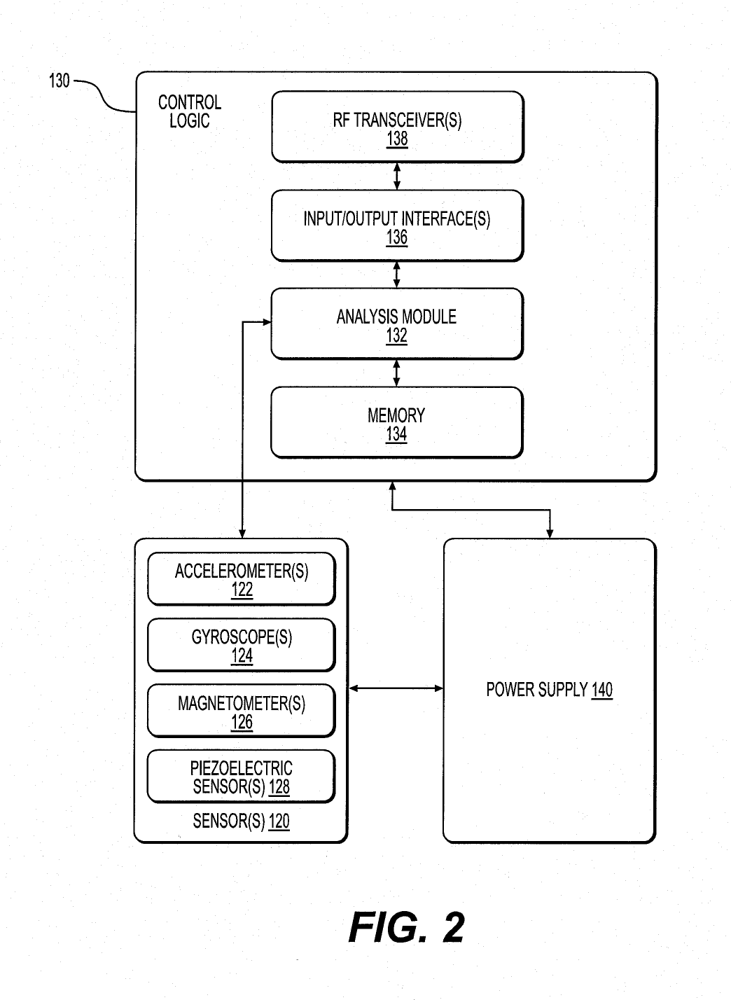

FIG. 1 is a schematic illustration of a wrist-based wearable device that may be adapted to work with electronic devices in accordance with some examples. FIG. 2 is a schematic illustration of an architecture for a wrist-based wearable device that may be adapted to work with electronic devices in accordance with some examples. Other arrangements may also be provided.

Referring to FIGS. 1-2, in some examples a wrist-based wearable device 100 may include a member 110 and a plurality of sensors 120 disposed along a length of the member 110. The sensors 120 may be communicatively coupled to a control logic 130 (or controller) by a suitable communication link. The control logic 130 may be communicatively coupled to one or more remote electronic devices 200 by a suitable communication link.

The control logic 130 may be or include a controller, an application specific integrated circuit (ASIC), a general purpose processor, a graphics accelerator, an application processor, and/or the like. The control logic 130 may include other features as may be described below.

The member 110 may be formed of any suitable rigid or flexible material such as a polymer, metal, cloth or the like. The member 110 may include an elastic or other material that allows the member 110 to fit snugly on a proximal side of a user's wrist, such that the sensors 120 are positioned proximate the wrist of a user.

The sensors 120 may include one or more sensors adapted to detect at least one of an acceleration, an orientation, or a position of the sensor, or combinations thereof. For example, the sensors 120 may include one or more accelerometers 122, gyroscopes 124, magnetometers 126, piezoelectric sensors 128, and/or the like. Other examples for hand gestures include electromyographic sensors (such as for an armband) and photoplethysmographic sensors (such as for heart-rate (pulse) monitoring). For ease of discussion, piezoelectric sensors may be described hereinafter.

The control logic 130 may be embodied as a general purpose processor, a network processor (that processes data communicated over a computer network), or other types of a processor (including a reduced instruction set computer (RISC) processor or a complex instruction set computer (CISC)).

The control logic 130 may include, or be coupled to, one or more input/output interfaces 136. In some examples input/output interface(s) may include, or be coupled to an RF transceiver 138 to transceive RF signals. The RF transceiver may be a wireless communication device. RF transceiver may implement a local wireless connection via a protocol such as, e.g., Bluetooth or 802.11X. IEEE 802.11a, b or g compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002) or other cellular type transceiver that can send/receive communication signals in accordance with various protocols, e.g., 2G, 3G, 4G, LTE, etc.

The control logic 130 may include, or be coupled to, a memory 134. The memory 134 may be implemented using volatile memory, e.g., static random access memory (SRAM), a dynamic random access memory (DRAM), nonvolatile memory, or non-volatile memory, e.g., phase change memory, NAND (flash) memory, ferroelectric random-access memory (FeRAM), nanowire-based non-volatile memory, memory that incorporates memristor technology, three dimensional (3D) cross point memory such as phase change memory (PCM), spin-transfer torque memory (STT-RAM) or NAND flash memory.

The control logic 130 may include an analysis module 132 to analyze signals generated by the sensors 120 and to determine a symbol or gesture associated with the signals. The signals, such as representing a gesture, may be transmitted to a remote electronic device 200 (or electronic apparatus) via the input/output interface 136. The wearable device 100 may include a wireless communication device to wirelessly communicate with external devices (such as external electronic devices). In some examples, the analysis module 132 may be implemented as logic instructions stored in non-transitory computer readable medium such as the memory 134 and executable by the control logic 130. In other examples, the analysis module 132 may be reduced to microcode or even to hard-wired circuitry on the control logic 130.

The analysis module 132 may also include an activity detector and a gesture classifier (or gesture classifier device). A portion of the analysis module 132 (or activity detector) may be provided at the wearable device for power savings. A portion of the analysis module 132 (or gesture classifier) may be at either the wearable device or at the remote electronic device. If the gesture classifier is provided at the remote electronic device, then a full signal waveform corresponding to the gesture may need to be transmitted to the remote electronic device.

A power supply 140 may be coupled to the sensors 120 and the control logic 130. For example, the power supply 140 may include one or more energy storage devices, e.g., batteries or the like.

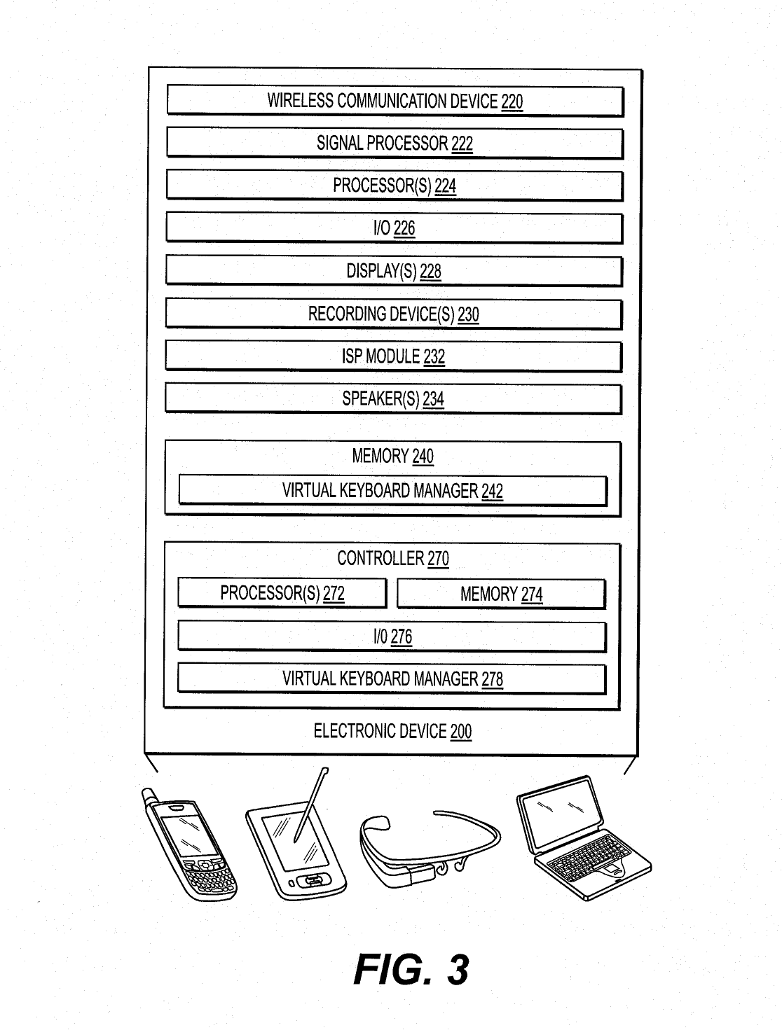

FIG. 3 is a schematic illustration of components of an electronic device that may be adapted to work with a wrist-based wearable device in accordance with some examples. The electronic device 200 may be embodied as a mobile telephone, a tablet computing device, a personal digital assistant (PDA), a notepad computer, a video camera, a wearable device like a smart watch, smart wrist band, smart headphone, and/or the like. Other arrangements of the electronic device may also be used.

In some examples, the electronic device 200 may include a wireless communication device 222 (i.e., an RF transceiver) to transceive RF signals and a signal processing module 222 to process signals received by the RF transceiver. The RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002). The electronic device 200 may include the wireless communication device to wirelessly communicate with the wearable device 100.

The electronic device 200 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some examples, the processor 224 may be one or more processors in the family of Intel® PXA27x processors available from Intel® Corporation of Santa Clara, Calif. Alternatively, other processors may be used, such as Intel's Itanium®, XEON™, ATOM™, and Celeron® processors. Also, one or more processors from other manufactures may be utilized. Moreover, the processors may have a single or multi core design.

In some examples, the memory module 240 may include random access memory (RAM); however, the memory module 240 may be implemented using other memory types such as dynamic RAM (DRAM), synchronous DRAM (SDRAM), and the like. The memory 240 may include one or more applications including a recording manager 242 that executes on the processor(s) 222.

The electronic device 200 may further include one or more input/output interfaces such as, e.g., a keypad 226 and one or more displays 228, speakers 234, and one or more recording devices 230. By way of example, recording device(s) 230 may include one or more cameras and/or microphones. An image signal processor 232 may be provided to process images collected by recording device(s) 230.

In some examples, the electronic device 200 may include a low-power controller 270 that may be separate from the processor(s) 224, described above. In the example depicted in FIG. 3 the controller 270 includes one or more processor(s) 272, a memory module 274, an I/O module 276, and a recording manager 278. In some examples, the memory module 274 may include a persistent flash memory module and the authentication module 276 may be implemented as logic instructions encoded in the persistent memory module, e.g., firmware or software. The I/O module 276 may include a serial I/O module or a parallel I/O module. Because the adjunct controller 270 is physically separate from the main processor(s) 224, the controller 270 can operate independently while the processor(s) 224 remains in a low-power consumption state (e.g., a sleep state). Further, the low-power controller 270 may be secure in the sense that the low-power controller 270 is inaccessible to hacking through the operating system.

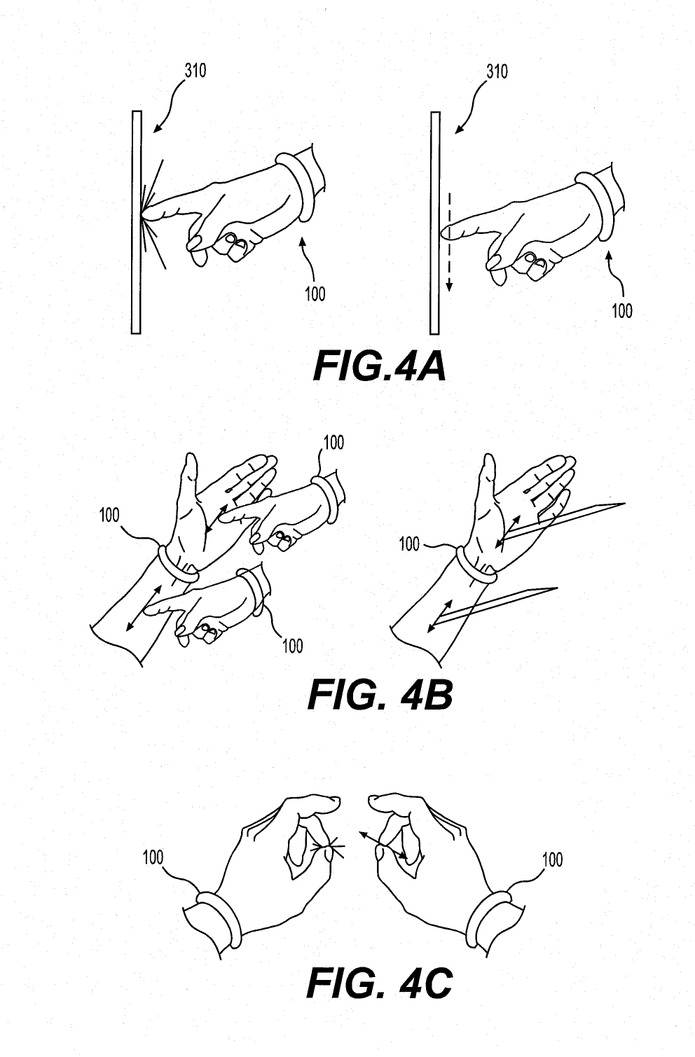

As described above, the wrist-based wearable device 100 may be disposed about a user's wrist and used to detect motion, position, and orientation, or combinations thereof. FIGS. 4A-4C are schematic illustrations of gestures that may be used with a wrist-based wearable device in accordance with some examples. For example, the wrist-based wearable device 100 may be used to detect a finger tap on a surface 310 or a finger slide on a surface 310, as shown in FIG. 4A. Alternatively, or in addition, a wrist-based wearable device 100 may be used to detect contact with a hand or arm of the user proximate the wrist-based wearable device 100, as shown in FIG. 4B. Alternatively, or in addition, the wrist-based wearable device 100 may be used to detect particular patterns of contact with the fingers of a user, as shown in FIG. 4C. Other gestures may also be detected and/or determined.

The wrist-based wearable device 100 may have a limited amount of power, such as within the power supply 140. The power supply 140 may be re-charged when connected to an external power source. However, power may be limited when the power supply 140 is not connected to the external power source.

At least one sensor may provide a plurality of signals (or sample signals) based on the detected movement of the sensor (i.e., based on movement of a user's wrist). The sensor may detect movement of the wearable device 100, and may provide a plurality of signals based on the detected movement. The signals may be used to determine, classify and/or identify a specific type of gesture made by the user wearing the wearable device 100. However, a non-negligible amount of power may be needed in order to classify (or determine) specific types of gestures (i.e., hand gestures) based on received signals, such as mechanical vibration signals, because of the constant recording of the gesture classifier. Embodiments may obtain power savings when the gesture classifier is not in constant use and the activity detector is in use.

Embodiments may determine whether or not gesture classification (or gesture identification) should be performed based on signals received from at least one sensor. If gesture classification is performed only when a valid gesture is performed by the user, then a large amount of power may be saved because a rate of hand gestures is relatively low for most applications. The gesture classification may be performed based on the signals received from the at least one sensor. In “low-gesture-rate” applications, it may be power-inefficient to record the signals (e.g. vibration signals) continuously and attempt continuous signal classification in an uninterrupted manner. For example, in applications such as controlling power point presentations, the rate of which a gesture to request an action from the power point (e.g. move one slide forward/backward) may be low. Another low-rate example may be music playback control. The user may need to request a change in a track being played only every several minutes. In these examples, one may not want the gesture classifier to be used all the time because most of the time, the sensor signals may correspond to system noise or unwanted gestures. In contrast, gestures from the user may be made at a higher rate such as to be used to control a robot arm performing a task or to control a car in a racing game. In this example, the user may want to steer the arm or the car away from obstacles very often.

Embodiments may determine when a gesture is likely to have been performed based on an analysis of the received signals (e.g. mechanical vibration signal) with a minimal amount of processing and memory. Gesture classification (or identification) may not be performed if the determination is that the gesture is not likely to have been performed (i.e., by determining no occurrence of a valid gesture pattern). Gesture classification (or identification) may be performed if the determination is that the gesture is likely to have been performed (i.e., by determining occurrence of a valid gesture pattern based on the received signals).

Gesture vibration signals, detected by a piezoelectric sensor (for example) may include a series of impulses of opposite polarity. This may be due to a wave nature of the signals generated and properties of the sensors. However, there may be a strong area of the signal having a polarity shift (i.e., positive to negative). Embodiments may identify (or determine) this strong area of signal change (based on polarity) and may use this characteristic to indicate a high probability (or occurrence) of a valid gesture pattern (i.e., a possible gesture activity). Otherwise, the received signals may not correspond to a valid gesture pattern (i.e., an actual gesture). In such a case, the signals may not be classified by the gesture classifier. This may save power consumption of the overall electronic system.

Embodiments may detect (or determine) gesture activity by analyzing a signal (or signals) in blocks of only four samples (at a time) and performing a calculation on the obtained samples. In at least one embodiment, the calculation may include only three addition operations and one multiplication operation. Embodiments may include other numbers of signals and/or other calculations. Embodiments may relate to conserving power within the wearable device 100 by controlling components within the device based on a determination regarding occurrence of a valid gesture pattern.

Embodiments may minimize power consumption (of the system) by determining when a gesture was likely performed and triggering a subsequent and more complex gesture classifier only when a gesture is determined to likely have been performed.

Embodiments may determine an occurrence of a valid gesture pattern or determine no occurrence of a valid gesture pattern. The determination may be made based on an analysis of received signals from the sensor. The gesture classifier may be active only a minimum amount of the time, as compared to constantly performing gesture classification (or gesture identification). If the determination is no occurrence of a valid gesture pattern (i.e., a gesture was not likely performed), then the gesture classifier may not be used to perform gesture classification, thereby saving power.

The gesture activity detector may determine occurrence (or probability) of a valid gesture pattern based on the signals from the sensor. If the determination is a determination of a valid gesture pattern, then at least the gesture classifier may be provided in a first mode. If the determination is a determination of no valid gesture pattern, then at least the gesture classifier may be provided in a second mode.

The first mode (or power-up mode) may be an active mode for the gesture classifier to receive power, and the gesture classifier may identify a specific gesture (by the user) based on the received signals.

The second mode (or power-down mode) may be a sleep mode for the gesture classifier, and in which power to the gesture classifier may be reduced to a minimal amount and/or eliminated. The second mode may be a lower power mode for at least the gesture classifier.

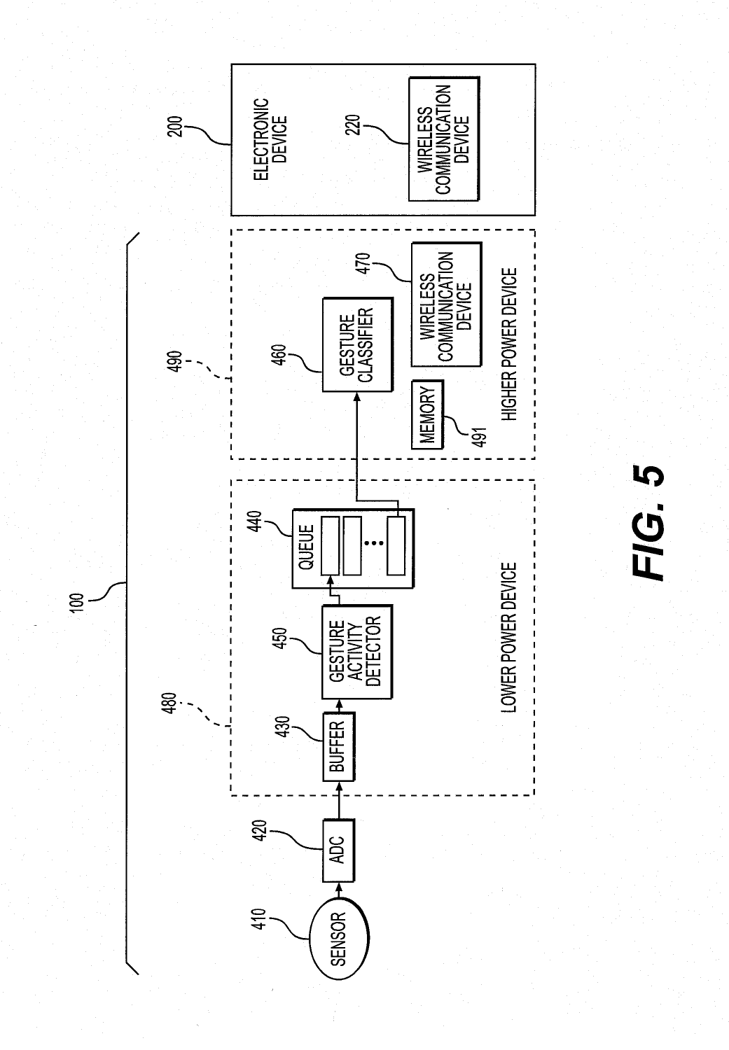

FIG. 5 shows an electronic system according to an example embodiment. Other embodiments and configurations may also be provided. The system includes the wearable device 100 (or wearable apparatus) and the electronic device 200. The wearable device 100 and the electronic device 200 may wirelessly communicate with each other. For example, the wearable device 100 may communicate gesture information when occurrence of a valid gesture pattern is determined to occur, and the gesture classifier may identify a specific type of the gesture (made by the user of the wearable device 100).

FIG. 5 shows a sensor 410 connected to an analog to digital converter (ADC) 420. The sensor 410 may correspond to the sensor 120 discussed above. For ease of discussion, the sensor 410 may be a piezoelectric sensor. The sensor 410 may provide a mechanical vibration signal, which may be an analog signal, based on detected movement of the wearable device 100. For example, the sensor 410 may detect movement of a user's wrist, and may provide a plurality of signals (or sample signals) based on the detected movement.

For example, piezoelectric sensors may provide an electrical voltage signal when the sensor gets deflected or deformed. When the piezoelectric sensor is in a stable shape, a voltage provided by the sensor may be zero. Therefore, whenever the user moves the hand or fingers, a vibration may make the sensor to be slightly deformed or deflected and consequently generate a signal different from zero. When the user is not moving the hand, the sensor is not being deformed or deflected and hence produces no signal. Noise, or not useful signals, may arise from hand motion that does not correspond to an intentional gesture.

The analog signal from the sensor 410 may be input to the ADC 420 where the signal may be conditioned and digitized. The ADC 420 may output digital signals to a buffer 430 where the digital signals may be temporarily stored. In at least one example, the buffer 430 may contain a maximum number of samples (hereafter called “Buff Size”). The buffer 430 may be a short area of memory to store a short period of the sensor signal, and large enough to hold a gesture signal. The buffer may get rewritten by new signals.

In at least one embodiment, signals may be output from the buffer 430 to the gesture activity detector 450.

FIG. 5 also shows the gesture activity detector 450 (or gesture activity detector device) that detects (or determines) occurrence of a valid gesture pattern (corresponding to a valid gesture). If the gesture activity detector 450 determines an occurrence of a valid gesture pattern, then the gesture activity detector 450 may trigger a subsequent classification by a gesture classifier 460 (or gesture classifier device). On the other hand, if the gesture activity detector 450 determines no occurrence of the valid gesture pattern, then the gesture classifier 460 is not triggered and/or power to the gesture classifier may be decreased (or maintained at low level).

The gesture activity detector 450 may receive signals from the buffer 430. The gesture activity detector 450 may be part of a processor (or controller) that may perform an algorithm, stored in a memory, to determine if the received signals correspond to occurrence of a valid gesture pattern (as compared to noise, for example).

A queue 440 may be provided after the activity detector 450. The queue 440 may account for latency inherent in signal processing to make a decision of whether a gesture was performed or not (by the activity detector 450) and which gesture (by the gesture classifier 460). If a queue is available, then several consecutive gestures may be detected because their signals may be available for analysis. In at least one embodiment, the queue 440 is provided after the activity detector 450 in order to avoid losing gestures. Thus, only probable gestures (i.e., valid gesture patterns) are stored in the queue 440 waiting to be classified by the gesture classifier 460. The gesture classifier 460 may be powered only when the queue 440 has elements waiting to be processed. If the queue 440 is empty, then the gesture classifier 460 may be provided in a sleep mode (or power-down mode).

In at least one embodiment, a queue may be provided between the buffer 430 and the activity detector 450.

FIG. 5 is a block diagram that shows components of the wearable device 100, namely the sensor 410, a lower power device 480 and a higher power device 490. As shown in FIG. 5, the lower power device 480 may include the buffer 430, the queue 440, and the gesture activity detector 450. Additionally, as shown in FIG. 5, the higher power device 490 may include the gesture classifier 460, a memory 491 and a wireless communication device 470.

The lower power device 480 may correspond to a small controller (or ASIC). The activity detector 450 may correspond to an algorithm in memory, and hardware within the small controller. This may be a specialized Arithmetic Logic Unit (ALU) rather than an algorithm in memory.

In at least one embodiment, the lower power device 480 may control when power is provided to the higher power device 490 based on the determination of the gesture activity detector 450. In at least one embodiment, the lower power device 480 may control when signals (from the sensor) are provided to the gesture classifier 460 based on the determination of the gesture activity detector 450. Operation of the gesture classifier 460 may be based on the determination of the gesture activity detector 450.

The gesture activity detector 450 (within the lower power device 480) may determine (or detect) occurrence of a valid gesture pattern (corresponding to a likely gesture) and trigger further classification by the gesture classifier 460 (within the higher power device 490). This may be accomplished by communication between the gesture activity detector 450 and the gesture classifier 460. For example, the gesture activity detector 450 may provide a signal (or signals) to the gesture classifier 460 such that the gesture classifier 460 receives power (i.e., power on) when the determination is an occurrence of a valid gesture pattern (i.e., the gesture is likely) and/or may provide a signal (or signals) to the gesture classifier 460 such that the gesture classifier 460 is powered off (or decreased in power) when the determination is no valid gesture pattern (i.e., the gesture is not likely). In at least one embodiment, the communication regarding occurrence of the valid gesture pattern may be between any component within the lower power device 480 and any component of the higher power device 490. Operation of the gesture classifier 460 may be based on the determination of the gesture activity detector 450.

Gesture signals (sensed by a sensor) may present a feature to trigger activity detection. This event may consist of a single, relatively strong signal transition (followed by or preceded by weaker signal transitions). The gesture activity detector 450 may identify a strongest event of polarity transition.

An example operation of the gesture activity detector 450 may now be provided. Other embodiments and examples may also be provided. The gesture activity detector 450 may obtain (or read) samples from the buffer 430. As one example, four samples (A, B, C and D) may be extracted from the buffer 430 based on a window. The i-iteration values may be assigned as follows:

A=Buffer[i];

B=Buffer[i+1];

C=Buffer[i+2]; and

D=Buffer[i+3].

The four different samples may then be analyzed to determine if the two samples have different signs (i.e., positive and negative signs). For example, a calculation of samples A and D being less than 0 implies that the samples A and D have different signs. This implies a zero crossing between the different samples. Initially only extreme values of the samples may be used to detect (or determine) a zero crossing. If the above calculation does not have a zero crossing, then the window may be moved to new samples. The window may move one sample at a time.

If a zero crossing does occur for the window (of four samples), the values of samples B and C may be used to calculate a difference in the amount of energy before and after. If the difference is larger than a prescribed value, then there is a high likelihood (or high probability) of a valid gesture pattern. If there is a high likelihood, then data within the buffer may be classified, analyzed and/or identified by the gesture classifier 460.

A section of size 2*m in the buffer (centered around the i-position) may be returned by the activity detector 450 as the probable gesture signal digital waveform. The gesture classifier 460 may then analyze this probable gesture signal. If the queue 440 is provided after the activity detector 450, then the activity detector 450 may transfer the probable gesture digital waveform (size 2*m) to the queue 440. The queue, having elements to process, may make the gesture classifier 460 to be powered on (i.e., provided in an active mode).

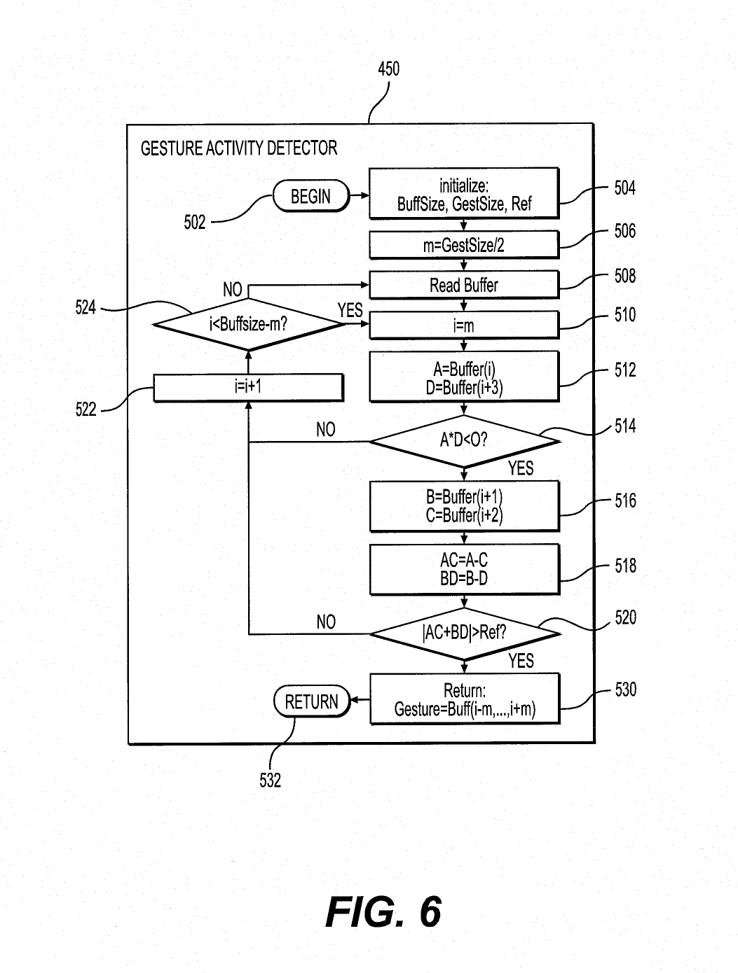

FIG. 6 is a flowchart of operations within a gesture activity detector according to an example embodiment. Other operations, orders of operations and embodiments may also be provided. As one example, the flowchart may be performed by hardware within the gesture activity detector 450 based on received signals. The flowchart may also be performed by logic, at least a portion of which is hardware.

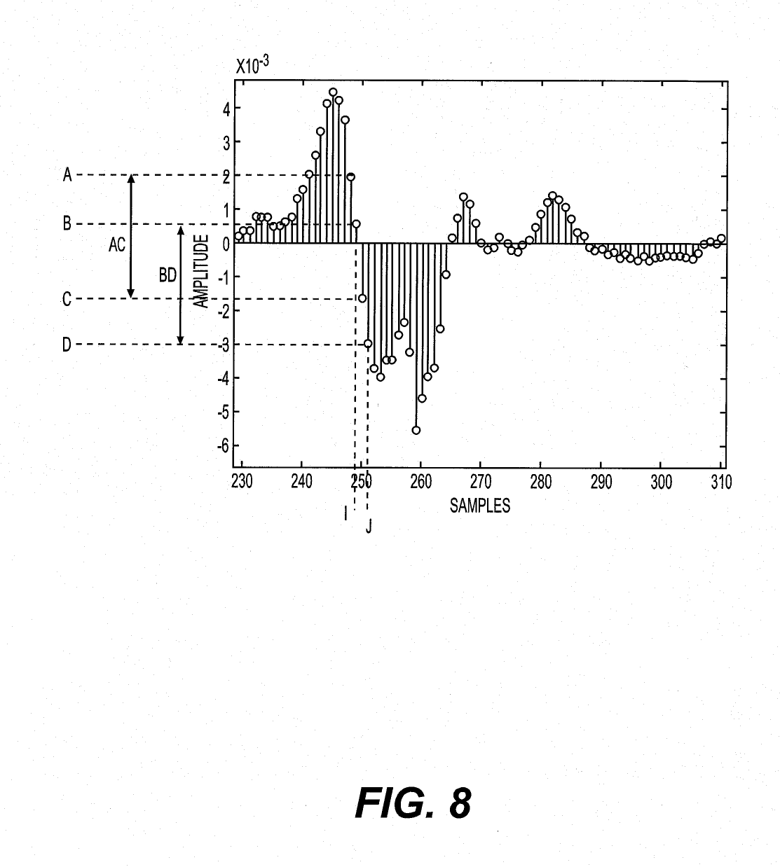

The flowchart of FIG. 6 shows operations of a gesture activity detector. The operations may take sample signals from the buffer 430 in sets (or window) during each cycle. The set (or window) may include 4 samples, such as a first sample A, a second sample B, a third sample C and a fourth sample D. The samples A, B, C, D may be seen in FIG. 8. Other numbers of samples may also be provided.

In each set (or window) of samples, if a sign (i.e., positive or negative) of the first sample A and a last sample D are opposite to each other, then a polarity transition (or zero crossing) is detected (or determined). If an amplitude difference of the first sample A and the third sample C plus an amplitude difference of the second sample B and the fourth sample D is large enough, then an occurrence of a valid gesture pattern is detected, and the operations may return the gesture signal or the index of the buffer where it was detected.

A reference amplitude level (“Ref”) may be used to indicate a strength or amplitude of the transition necessary in order to consider the signals to be a valid gesture pattern. The Ref level may depend on hardware of the system.

The flowchart of FIG. 6 may begin at operation 502. In operation 504, an initialize process may occur to obtain values such as BuffSize (maximum number of sample in the buffer), GestSize, and Ref (reference amplitude level). Subsequently, in operation 506, a value of m may be determined by dividing GestSize by 2. GestSize is the expected length (in bits) of the gesture waveform. Thus “m” may be half of the gesture size or length.

In operation 508, samples may be read from the buffer. In operation 510, the value of i equals m (i.e., i=m). In operation 512, a value of A may be determined based on Buffer(i) and a value of D may be determined based on Buffer(i+3).

Operation 514 is a determination of A*D<0. This determination is a determination of whether the sign changes (or zero crossing) for either of the samples (Sample A and Sample D). If the determination in operation 514 is YES, then operation 516 determines a value of B based on Buffer(i+1) and determines a value of C based on Buffer(i+2).

In operation 518, a value AC is determined by subtracting C from A (i.e., AC=A−C), and a value BD is determined by subtracting D from B (i.e., BD=B−D).

In operation 520, a determination may be made regarding an absolute value of AC+BD being greater than Ref. If the determination is YES, then operations 530 return and Gesture=Buff(i−m, . . . i+m). In operation 532, operations may return, such as to the beginning operation of the flowchart (i.e., operation 502).

At operation 532, the section of the buffer size 2*m around position i is transferred to the gesture classifier as a probable gesture. If the queue 440 is provided between the activity detector 450 and the gesture classifier 460, then the probable gesture may be transferred to a queue position.

At operation 532, the execution may move to a series of events. If the wearable device remains active (i.e., the user still wants to use gesture recognition), then execution may go back to the beginning (operation 502).

If the determination is NO in operation 514, then operation 522 increases the value of i by 1 (i.e., i=i+1). In operation 524, a determination is made whether i<Buffsize−m. If the determination is YES, then operation proceeds to operation 510. On the other hand, if the determination is NO, then operations proceed to operation 508.

Operation 522 moves the analysis one sample further. Operation 524 verifies that the analysis is made only until the sample that is m-samples before the end of the buffer. The algorithm starts with i=m at operation 510. This is because m is half the gesture size and because the area of strong sign shift occurs roughly at a middle of the gesture signal.

Thus, if the strong sign transition is detected within km section of the buffer, the gesture would have been captured incomplete (i.e., the first half would be missing). The same would occur for the stop at operation 524. If the strong sign transition occurs beyond i=BuffSize−m, then the second half of the gesture signal may be missed.

If the determination in operation 520 is NO, then operations proceed to operation 522.

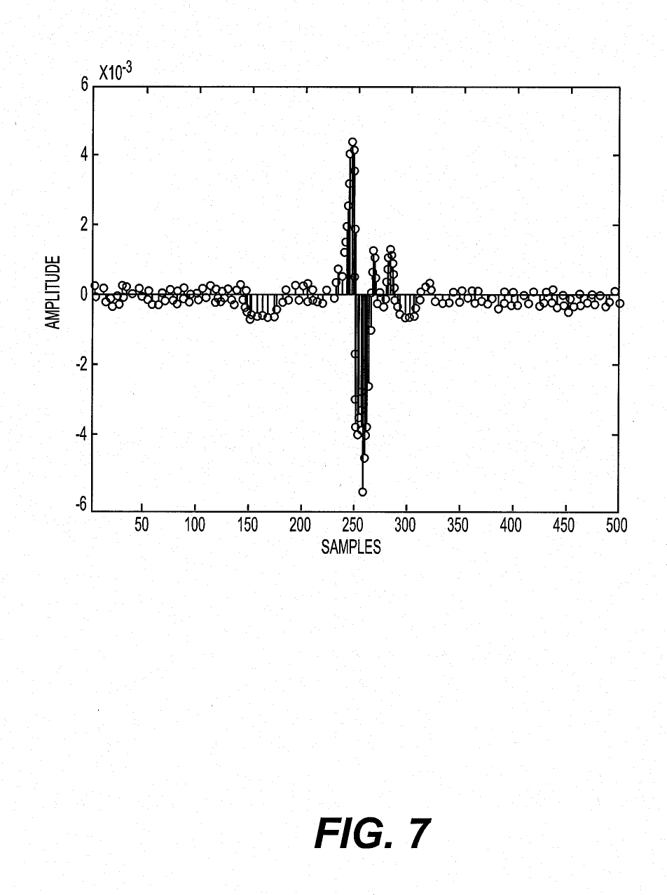

FIG. 7 is a graph showing Samples and Amplitude for a snap gesture. FIG. 8 is a close up view of the gesture signal from FIG. 7. Other graphs, data and embodiments may also be provided.

The data of FIGS. 7-8 is based on a single sensor wearable device in which a sampling rate of 1 kS/s with Buff Size=500 samples, and Gest Size between 50 and 150 samples.

FIG. 7 shows a signal buffer with a snap gesture, whereas FIG. 8 shows a close up view of the buffer samples that capture the gesture. FIG. 8 shows four samples (A, B, C, D) that may trigger an occurrence of a valid gesture pattern according to the flowchart of FIG. 6.

More specifically. FIG. 7 shows a signal buffer of 0.5 s from the sensor sampled at 1 kS/s. A gesture signal can be clearly identified starting around sample 223 and ending around sample 300.

The following examples pertain to further embodiments.

Example 1 is an electronic apparatus comprising: a sensor to detect movement of the apparatus, and to provide a plurality of signals based on the detected movement; a gesture activity detector to receive the signals from the sensor, and to determine occurrence of a valid gesture pattern based on the received signals; and a gesture classifier to identify a gesture based on the signals from the sensor, wherein operation of the gesture classifier is based on the determination of the gesture activity detector.

In Example 2, the subject matter of Example 1 can optionally include in response to the gesture activity detector determining the occurrence of the valid gesture pattern, the gesture classifier to identify a specific gesture based on the signals received from the sensor.

In Example 3, the subject matter of Examples 1-2 can optionally include in response to the gesture activity detector determining no occurrence of the valid gesture pattern, the gesture classifier to be provided in a power down mode.

In Example 4, the subject matter of Example 1 can optionally include in response to the gesture activity detector determining the occurrence of the valid gesture pattern, the gesture classifier to be provided in a first mode, and wherein in response to the gesture activity detector determining no occurrence of the valid gesture pattern, the gesture classifier to be provided in a second mode.

In Example 5, the subject matter of Example 4 can optionally include the first mode is an active mode for the gesture classifier, and the second mode is a sleep mode for the gesture classifier.

In Example 6, the subject matter of Example 4 can optionally include the first mode is an active mode for the gesture classifier, and the second mode is a low power mode for the gesture classifier.

In Example 7, the subject matter of Examples 1 and 4-6 can optionally include a power supply to supply power to at least the gesture classifier.

In Example 8, the subject matter of Example 7 can optionally include the supply of power to the gesture classifier is based on the determination of the gesture activity detector.

In Example 9, the subject matter of Examples 1 and 4-6 can optionally include the gesture activity detector to analyze the plurality of signals from the sensor.

In Example 10, the subject matter of Example 9 can optionally include the gesture activity detector analyzes the signals by determining any zero crossing from the plurality of signals.

In Example 11, the subject matter of Example 9 can optionally include the gesture activity detector analyzes the signals by determining a difference between at least two of the plurality of signals.

In Example 12, the subject matter of Example 1 can optionally include a buffer to store the plurality of signals.

In Example 13, the subject matter of Example 1 can optionally include an analog to digital converter to convert analog signals from the sensor into digital signals.

In Example 14, the subject matter of Examples 1 and 4-6 can optionally include the gesture activity detector is part of a first processor, and the gesture classifier is part of a second processor.

In Example 15, the subject matter of Example 1 can optionally include the sensor is a piezoelectric sensor.

In Example 16, the subject matter of Examples 1 and 4-6 can optionally include a wireless communication device to wirelessly communicate gesture information to an external device.

Example 17 is an electronic apparatus comprising: detecting means for providing a plurality of signals based on detected movement; determining means for determining occurrence of a valid gesture pattern based on the received signals; and identifying means for identifying a gesture based on the received signals, and operation of the means for identifying is based on the determination of the means for determining.

In Example 18, the subject matter of Example 17 can optionally include in response to the determining means determining the occurrence of the valid gesture pattern, the identifying means identifying a specific gesture based on the signals.

In Example 19, the subject matter of Examples 17-18 can optionally include in response to the determining means determining no occurrence of the valid gesture pattern, the identifying means to be provided in a power down mode.

In Example 20, the subject matter of Example 17 can optionally include in response to the determining means determining the occurrence of the valid gesture pattern, the identifying means to be provided in a first mode, and wherein in response to the determining means determining no occurrence of the valid gesture pattern, the identifying means to be provided in a second mode.

In Example 21, the subject matter of Example 20 can optionally include the first mode is an active mode for the identifying means, and the second mode is a sleep mode for the identifying means.

In Example 22, the subject matter of Example 20 can optionally include the first mode is an active mode for the identifying means, and the second mode is a low power mode for the identifying means.

In Example 23, the subject matter of Examples 17 and 20-22 can optionally include a power supply to supply power to at least the identifying means.

In Example 24, the subject matter of Example 23 can optionally include the supply of power to the identifying means is based on the determination of the determining means.

In Example 25, the subject matter of Example 17 can optionally include the determining means to analyze the plurality of signals.

In Example 26, the subject matter of Example 25 can optionally include the determining means analyzes the signals by determining any zero crossing from the plurality of signals.

In Example 27, the subject matter of Example 25 can optionally include the determining means analyzes the signals by determining a difference between at least two of the plurality of signals.

In Example 28, the subject matter of Example 17 can optionally include a buffer to store the plurality of signals.

In Example 29, the subject matter of Example 17 can optionally include an analog to digital converter to convert analog signals from the sensor into digital signals.

In Example 30, the subject matter of Example 17 can optionally include the determining means is part of a first processor, and the identifying means is part of a second processor.

In Example 31, the subject matter of Example 17 can optionally include the detecting means is a sensor.

In Example 32, the subject matter of Examples 17 and 20-22 can optionally include a wireless communication device to wirelessly communicate gesture information to an external device.

Example 33 is a method comprising: detecting movement of a sensor; receiving a plurality of signals from the sensor based on the detected movement; determining an occurrence of a valid gesture pattern based on the received signals; and changing operation of a gesture classifier based on the determination of the occurrence of the valid gesture pattern.

In Example 34, the subject matter of Example 33 can optionally include in response to determining the occurrence of the valid gesture pattern, identifying, at the gesture classifier, a specific gesture based on signals received from the sensor.

In Example 35, the subject matter of Examples 33-34 can optionally include in response to determining no occurrence of the valid gesture pattern, providing the gesture classifier in a power down mode.

In Example 36, the subject matter of Example 33 can optionally include in response to determining the occurrence of the valid gesture pattern, providing the gesture classifier in a first mode, and in response to determining no occurrence of the valid gesture pattern, providing the gesture classifier in a second mode.

In Example 37, the subject matter of Example 36 can optionally include the first mode is an active mode for the gesture classifier, and the second mode is a sleep mode for the gesture classifier.

In Example 38, the subject matter of Example 36 can optionally include the first mode is an active mode for the gesture classifier, and the second mode is a low power mode for the gesture classifier.

In Example 39, the subject matter of Examples 33 and 36-38 can optionally include determining an occurrence of a valid gesture pattern includes analyzing the plurality of signals from the sensor.

In Example 40, the subject matter of Example 39 can optionally include analyzing the plurality of signals includes determining any zero crossing from the plurality of signals.

In Example 41, the subject matter of Example 39 can optionally include analyzing the plurality of signals includes determining a difference between at least two of the plurality of signals.

In Example 42, the subject matter of Examples 33 and 36-38 can optionally include wirelessly communicating gesture information from the gesture classifier to an external electronic device.

Example 43 is a machine-readable medium comprising one or more instructions that when executed cause a processor to perform one or more operations to: determine an occurrence of a valid gesture pattern based on signals received from a sensor; and change operation of a gesture identifier based on the determination of the valid gesture pattern.

In Example 44, the subject matter of Example 43 can optionally include the one or more operations further to identify, at the gesture classifier, a specific gesture in response to determining the occurrence of the valid gesture pattern.

In Example 45, the subject matter of Example 43-44 can optionally include the one or more operations to provide the gesture classifier in a power down mode in response to determining no valid gesture pattern.

In Example 46, the subject matter of Example 43 can optionally include the one or more operations to provide the gesture classifier in a first mode in response to determining the occurrence of the valid gesture pattern, and providing the gesture classifier in a second mode in response to determining no valid gesture pattern.

In Example 47, the subject matter of Example 46 can optionally include the first mode is an active mode for the gesture classifier, and the second mode is a sleep mode for the gesture classifier.

In Example 48, the subject matter of Example 46 can optionally include the first mode is an active mode for the gesture classifier, and the second mode is a low power mode for the gesture classifier.

In Example 49, the subject matter of Examples 43 and 46-48 can optionally include to determine the occurrence of the valid gesture pattern includes to analyze the plurality of signals received from the sensor.

In Example 50, the subject matter of Example 49 can optionally include to analyze the plurality of signals includes to determine any zero crossing from the plurality of signals.

In Example 51, the subject matter of Example 49 can optionally include to analyze the plurality of signals includes to determine a difference between at least two of the plurality of signals.

Example 52 is an electronic system, comprising: a wearable device that includes a sensor to detect movement of the wearable device, a gesture activity detector to determine an occurrence of a valid gesture pattern based on signals received from the sensor, and a gesture classifier to identify a gesture, and operation of the gesture classifier is based on the determination of the gesture activity detector; and an electronic device to receive gesture information from the wearable device.

In Example 53, the subject matter of Example 52 can optionally include in response to the gesture activity detector determining the occurrence of the valid gesture pattern, the gesture classifier to identify a specific gesture based on the signals received from the sensor.

In Example 54, the subject matter of Examples 52-53 can optionally include in response to the gesture activity detector determining no occurrence of the valid gesture pattern, the gesture classifier to be provided in a power down mode.

In Example 55, the subject matter of Example 52 can optionally include in response to the gesture activity detector determining the occurrence of the valid gesture pattern, the gesture classifier to be provided in a first mode, and wherein in response to the gesture activity detector determining no occurrence of the valid gesture pattern, the gesture classifier to be provided in a second mode.

In Example 56, the subject matter of Example 55 can optionally include the first mode is an active mode for the gesture classifier, and the second mode is a sleep mode for the gesture classifier.

In Example 57, the subject matter of Example 55 can optionally include the first mode is an active mode for the gesture classifier, and the second mode is a low power mode for the gesture classifier.

In Example 58, the subject matter of Examples 52 and 55-57 can optionally include the wearable device includes a power supply to supply power to at least the gesture classifier.

In Example 59, the subject matter of Example 58 can optionally include the supply of power to the gesture classifier is based on the determination of the gesture activity detector.

In Example 60, the subject matter of Example 52 can optionally include the gesture activity detector to analyze the signals from the sensor.

In Example 61, the subject matter of Example 60 can optionally include the gesture activity detector analyzes the signals by determining any zero crossing from the signals.

In Example 62, the subject matter of Example 60 can optionally include the gesture activity detector analyzes the signals by determining a difference between at least two of the signals.

In Example 63, the subject matter of Example 52 can optionally include the wearable device includes a buffer to store the signals from the sensor.

In Example 64, the subject matter of Example 63 can optionally include the wearable device includes an analog to digital converter to convert analog signals from the sensor into digital signals.

In Example 65, the subject matter of Example 52 can optionally include the gesture activity detector is part of a first processor, and the gesture classifier is part of a second processor.

In Example 66, the subject matter of Example 52 can optionally include the sensor is a piezoelectric sensor.

In Example 67, the subject matter of Example 52 can optionally include the wearable device includes a wireless communication device to wirelessly communicate gesture information to the electronic device.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic apparatus comprising:
a sensor to detect movement of the apparatus, and to provide a plurality of signals based on the detected movement;
a gesture activity detector to receive the signals from the sensor, and to determine occurrence of a valid gesture pattern based on the received signals; and
a gesture classifier to identify a gesture based on the signals from the sensor, wherein operation of the gesture classifier is based on the determination of the gesture activity detector.

2. The electronic apparatus of claim 1, wherein in response to the gesture activity detector determining the occurrence of the valid gesture pattern, the gesture classifier to identify a specific gesture based on the signals received from the sensor.

3. The electronic apparatus of claim 2, wherein in response to the gesture activity detector determining no occurrence of the valid gesture pattern, the gesture classifier to be provided in a power down mode.

4. The electronic apparatus of claim 1, wherein in response to the gesture activity detector determining the occurrence of the valid gesture pattern, the gesture classifier to be provided in a first mode, and wherein in response to the gesture activity detector determining no occurrence of the valid gesture pattern, the gesture classifier to be provided in a second mode.

5. The electronic apparatus of claim 4, wherein the first mode is an active mode for the gesture classifier, and the second mode is a sleep mode for the gesture classifier.

6. The electronic apparatus of claim 4, wherein the first mode is an active mode for the gesture classifier, and the second mode is a low power mode for the gesture classifier.

7. The electronic apparatus of claim 1, further comprising a power supply to supply power to at least the gesture classifier.

8. The electronic apparatus of claim 7, wherein the supply of power to the gesture classifier is based on the determination of the gesture activity detector.

9. The electronic apparatus of claim 1, wherein the gesture activity detector is part of a first processor, and the gesture classifier is part of a second processor.

10. The electronic apparatus of claim 1, further comprising a wireless communication device to wirelessly communicate gesture information to an external device.

11. An electronic apparatus comprising:
detecting means for providing a plurality of signals based on detected movement;
determining means for determining occurrence of a valid gesture pattern based on the received signals; and
identifying means for identifying a gesture based on the received signals, and operation of the means for identifying is based on the determination of the means for determining.

12. The electronic apparatus of claim 11, wherein in response to the determining means determining the occurrence of the valid gesture pattern, the identifying means identifying a specific gesture based on the signals.

13. The electronic apparatus of claim 12, wherein in response to the determining means determining no occurrence of the valid gesture pattern, the identifying means to be provided in a power down mode.

14. The electronic apparatus of claim 11, wherein in response to the determining means determining the occurrence of the valid gesture pattern, the identifying means to be provided in a first mode, and wherein in response to the determining means determining no occurrence of the valid gesture pattern, the identifying means to be provided in a second mode.

15. The electronic apparatus of claim 14, wherein the first mode is an active mode for the identifying means, and the second mode is a sleep mode for the identifying means.

16. The electronic apparatus of claim 20, wherein the first mode is an active mode for the identifying means, and the second mode is a low power mode for the identifying means.

17. A method comprising:
detecting movement of a sensor;
receiving a plurality of signals from the sensor based on the detected movement;
determining an occurrence of a valid gesture pattern based on the received signals; and
changing operation of a gesture classifier based on the determination of the occurrence of the valid gesture pattern.

18. The method of claim 17, wherein in response to determining the occurrence of the valid gesture pattern, identifying, at the gesture classifier, a specific gesture based on signals received from the sensor.

19. The method of claim 18, wherein in response to determining no occurrence of the valid gesture pattern, providing the gesture classifier in a power down mode.

20. The method of claim 17, wherein in response to determining the occurrence of the valid gesture pattern, providing the gesture classifier in a first mode, and in response to determining no occurrence of the valid gesture pattern, providing the gesture classifier in a second mode.
